(19) United States
(12) Patent Application Publication
(10) Pub. No.: US 2007/0105747 A1
(43) Pub. Date: May 10, 2007

(54) Control of body odours

(76) Inventors: Keith Douglas Perring, Ashford (GB); John Martin Behan, Ashford (GB); Paula Maria Cawkill, Ashford (GB); Michael Gordon Evans, Canterbury (GB)

Correspondence Address: MORGAN LEWIS & BOCKIUS LLP, 1111 PENNSYLVANIA AVENUE NW, WASHINGTON, DC, 20004, US

(21) Appl. No.: 10/556,302

(22) PCT Filed: Apr. 30, 2004
(86) PCT No.: PCT/GB04/01862

§ 371 Date: Nov. 3, 2006

(30) Foreign Application Priority Data
May 9, 2003 (GB) 0310694.5
Sep. 24, 2003 (GB) 0322357.5

(51) Int. Cl. A61Q 13/00

(52) U.S. Cl. 512/2

(57) ABSTRACT

The invention concerns the control of body odours, particularly odours (other than axillary malodour) associated with body fluids and solids, by use of low odour compositions of fragrance materials. The composition of fragrance material preferably includes at least 5 of one or more musks and at least 5% of one or more salicylates.

### FIELD OF THE INVENTION

This invention concerns the control of body odours other than axillary malodour.

### BACKGROUND OF THE INVENTION

EP 0404470A1 and U.S. Pat. No. 5,501,805 concern compositions of fragrance materials that have in themselves a low or imperceptible level of fragrance, i.e. a low odour intensity, yet which can confer deodorant effects in use. Such compositions may be referred to for brevity as “low odour compositions”. These prior art documents disclose the use of such low odour compositions in detergent products and personal body underarm deodorant compositions (for combating axillary malodour).

It has now surprisingly been found that such low odour compositions also find use in combating other body odours.

### SUMMARY OF THE INVENTION

In one aspect the present invention provides a method of counteracting or reducing odours associated with bodily fluids or solids, other than axillary malodour, comprising providing in the vicinity of the bodily fluid or solid or source thereof a composition of fragrance materials having an odour intensity index of less than about 110, excluding. a method of counteracting or reducing odours associated in use with an article selected from sanitary towels or napkins and panty liners.

The invention also covers the use as a material for counteracting or reducing odours associated with bodily fluids or solids, other than axillary malodour, of a composition of fragrance materials having an odour intensity index of less than about 110, excluding use for counteracting or reducing odours associated in use with an article selected from sanitary towels or napkins and panty liners.

A further aspect of the invention provides use of a composition of fragrance materials having an odour intensity index of less than about 110 in an article, for counteracting or reducing odours associated with bodily fluids or solids, other than axillary malodour, excluding use for counteracting or reducing odours associated in use with an article selected from sanitary towels or napkins and panty liners.

The invention also provides an article other than a sanitary towel or napkin or a panty liner for counteracting or reducing odours associated with bodily fluids or solids, other than axillary malodour, wherein the article includes a composition of fragrance materials having an odour intensity index of less than about 110.

The invention thus does not cover methods of or uses for counteracting or reducing odours associated in use with an article selected from sanitary towels or napkins and panty liners, i.e. odours associated with products of the female genito-urinary tract, particularly menstrual or catamenial fluids and vaginal fluids, nor does the invention cover articles in the form of sanitary towels or napkins and panty liners.

The invention does, however, cover applications relating to odours associated with other bodily fluids and solids, including urine and faeces, and so covers articles including incontinence pads, nappies or diapers etc.

In all aspects of the invention, references to odour intensity index mean a value obtained by the odour intensity index method set out in EP 0404470 (based on a comparison with the odour intensity of a control sample of a 10% solution of benzyl acetate in dipropylene glycol, which corresponds to an index of 100).

It is preferred to use a composition of fragrance materials having an odour intensity index of less than about 105, more preferably less than about 100.

The composition of fragrance materials may optionally have a malodour reduction value of at least about 0.25, possibly at least about 0.5, or an odour reduction value of at least about 0.25, possibly at least about 0.5. References to malodour reduction value mean a value when tested by the procedure set out in EP 0147191; and references to odour reduction value mean a value when tested by the procedure set out in EP 0003172. EP 0404470, EP 0147191 and EP 0003172 are incorporated herein by reference.

It is to be understood that in this specification, expression such as ‘perfume’ and ‘fragrance’ extend to compositions of which the odour intensity may be so low as to be imperceptible in use.

By using a low odour composition, the present invention can enable undesirable body odours to be counteracted or reduced in a discrete manner without providing an overt fragrance that, while possibly pleasant in itself, might also be considered by the user to be undesirable, particularly given the current trend for providing fragrance-free products. Examples of suitable perfumery materials for incorporation into a composition of fragrance materials for use in the invention (i.e. a low odour composition) are given in EP 0404470 and U.S. Pat. No. 5,501,805. In general, any of a wide range of perfumery materials may be incorporated into the compositions, provided that the basis of selection is such as to provide a deodorant effect, and the odour intensity index of the resulting composition is as defined above.

Extensive directions for the selection of materials in order to provide a deodorant effect are given for example in EP 0147191, EP 0003172, and U.S. Pat. No. 4,304,679, all three documents being incorporated herein by reference.

It is helpful if the bulk of the individual ingredients chosen for the composition also individually possess an odour intensity index less than about 110, preferably less than about 100, or even lower. Small quantities of more intense materials may, however, be tolerated, e.g. for the purpose of adjusting the mild perfume note which may be given by the overall composition.

The composition preferably comprises at least 5% w/w, more preferably at least 10% w/w, yet more preferably at least 20 % w/w of at least one musk, based on the total weight of the composition (including any solvents). Where one or more musks are present, either in these or in other amounts, they can usefully be selected from musks such as those listed below:

| Trademark or | |
|---|---|
| Trivial Name: | Generic name: |
| Ambrettolide | Cyclohexadecen-7-olide |
| Celestolide (IFF) | 4-Acetyl-6-tert-butyl-1,1- |
| | dimethylindane |
| Dihydroambrettolide | Cyclohexadecanolide |
| Ethylene brassylate | cyclo-1,13-ethylenedioxy-tridecan- |
| | 1,13-dione |
| Exaltolide (F) | Cyclopentadecanolide |
| Exaltone (F) | Cyclopentadecanone |
| Habanolide (F) | 1-oxa-5(6)-cyclohexadecen-16-one |
| Galaxolide (IFF) | 1,3,4,6,7,8-hexahydro-4,6,6,7,8.8- |
| | hexamethylcyclopenta-2-benzopyran |
| Moskene (GIV) | 1,1,3,3,5-Pentamethyl-4,6- |
| | dinitroindane |
| Musk ambrette | 2,4-dinitro-3-methyl-6-tert- |
| | butylanisole |
| Musk Ketone | 4-tert-butyl-3,5-dinitro-2,6- |
| | dimethylacetophenone |
| Musk MC4 (SA) | Ethylene 1,12-dodecanedioate |
| Musk R1 (Q) | 11-Oxahexadecanolide |
| Musk tibetine | 2-tert-butyl-1,3-dinitrol-4,5,6- |
| | trinitrobenzene |
| Musk xylol | 1-tert-butyl-3,5-dimethyl-2,4,6- |
| | trinitrobenzene |
| Phantolide (PFW) | 5-Acetyl-1,1,2,3,3,6- |
| | hexamethylindane |
| Tonalid (PFW) | 1,1,2,4,4,7-Hexamethyl-6-acetyl- |
| | 1,2,3,4-tetrahydronaphthalene |
| Traseolide | 6-acetyl-1-isopropyl-2,3,3,5- |
| | tetramethylindane |
| Versalide (PFW) | 1,1,4,4-tetramethyl-6-acetyl-7-ethyl- |
| | 1,2,3,4-tetrahydronaphthalene |

Suppliers indicated in brackets above are as follows:
F = Firmenich
GIV = Givaudan
IFF = International Flavours & Fragrances
PFW = Polak's Frutal Works
SA = Soda Aromatics
Q = Quest International

Preferred musks include cyclohexadecanolide, cyclopentadecanone, ethylene brassylate, ethylene dodecanedioate and musk R1.

The quantity of musk will generally not exceed 70%, more likely not exceed 60% by weight so that other (non-musk) perfume components provide at least 30% more likely at least 40% by weight of the total weight of the perfume composition (including any solvents).

The composition preferably comprises at least 5% w/w, more preferably at least 10% w/w of at least one salicylate, preferably salicylates of aliphatic or arylaliphatic alcohols containing at least three carbon atoms notably 3 to 10 carbon atoms. The amount of salicylate is based on the total weight of the composition, including any solvents. Possible salicylates include:
amyl salicylate
isoamyl salicylate
isobutyl salicylate
cis-3-hexenyl salicylate
hexyl salicylate
cyclohexyl salicylate
benzyl salicylate
phenylethyl salicylate
propyl salicylate
isopropyl salicylate

Preferred salicylates include benzyl salicylate, cis-3-hexenyl salicylate, cyclohexyl salicylate, hexyl salicylate and phenylethyl salicylate.

It is also preferred that the composition contains at least 5% w/w, more preferably at least 10% w/w, most preferably at least 20% w/w of other perfume ingredients which are neither musk nor salicylate nor solvent that is odourless or substantially odourless, based on the total weight of the composition.

It is thus preferred to use a composition of fragrance materials comprising (a) an amount of at least 5% w/w of at least one musk, based on the total weight of the composition, (b) at least 5% of at least one salicylate, based on the total weight of the composition, and (c) at least 5% of other fragrance materials (possibly including odiferous solvents) which are neither musk nor salicylate nor odourless or substantially odourless solvent, based on the total weight of the composition.

The musk and salicylate materials are conveniently selected from the lists given above.

Perfumery solvents with no odour or with very low odour (referred to as odourless or substantially odourless) may be optionally included up to a limit of 80% by weight. Typical perfumery solvents include diethyl phthalate, dipropylene glycol, triacetin, benzyl benzoate, triethyl citrate, Hercolyn D (TM Hercules), isopropyl myristate and acetyl tributylcitrate. In some cases it may be desirable or appropriate to include odiferous perfumery solvent or solvents in small quantity.

Preferred musks and salicylates are listed in Table 1 below, which also includes preferred ingredients with low odour which may usefully be employed.

TABLE 1

| | CATEGORY | | |
|---|---|---|---|
| COMPONENT | MUSK | SALICYLATE | OTHER |
| ACETYL CEDRENE | | | 1 |
| BENZYL ALCOHOL | | | 1 |
| BENZYL CINNAMATE | | | 1 |
| BENZYL SALICYLATE | | 1 | |
| CINNAMIC ALCOHOL | | | 1 |
| CINNAMYL CINNAMATE | | | 1 |
| cis-3-HEXENYL SALICYLATE | | 1 | |
| CYCLOHEXADECANOLIDE | 1 | | |
| CYCLOHEXYL SALICYLATE | | 1 | |
| CYCLOPENTADECANONE | 1 | | |
| ETHYLENE BRASSYLATE | 1 | | |
| FLOROSA (TM) (Quest) | | | 1 |
| GERANYL PHENYLACETATE | | | 1 |
| HABANOLIDE (TM) (Firmenich) | 1 | | |
| HEXYL CINNAMIC ALDEHYDE | | | 1 |
| HEXYL SALICYLATE | | 1 | |
| ISOBORNYL CYCLOHEXANOL | | | 1 |
| ISOBUTYL BENZOATE | | | 1 |
| ISOBUTYL CINNAMATE | | | 1 |
| LINALYL BENZOATE | | | 1 |
| LINALYL CINNAMATE | | | 1 |
| MEFROSOL (TM) (Quest) | | | 1 |
| METHYL DIHYDROJASMONATE | | | 1 |
| ETHYLENE DODECANEDIOATE | 1 | | |
| MUSK R1 (TM) (Quest) | 1 | | |
| PHENOXYETHANOL | | | 1 |
| PHENYLETHYL | | | 1 |
| PHENYLACETATE | | | |
| PHENYLETHYL SALICYLATE | | 1 | |
| TETRAHYDROLINALOL | | | 1 |

EP 0404470 and U.S. Pat. No. 5,501,805 list many other examples of perfume materials useful in compositions for use in the invention.

It is preferred to use a composition of fragrance materials including one or more musks in an amount in the range 5 to 25 % by weight and one or more salicylates in an amount in the range 5 to 20% by weight, based on the total weight of the composition (including any solvents). The composition desirably also contains other perfumery ingredients (possibly including odiferous solvents), which are neither musk, salicylate nor odourless or substantially odourless solvent, in an amount of up to 50% by weight based on the total weight of the composition. The composition desirably includes one or more solvents that are odourless or substantially odourless in an amount in the range 25 to 60% by weight, based on the total weight of the composition.

The composition of fragrance materials preferably contains at least five different components, and in practice may contain considerably more components, being formulated in known manner to give a composition with desired fragrance characteristics (of low odour intensity). Examples of preferred compositions are given in the Examples below. Reference is also made to the Examples of EP 0404470 and U.S. Pat. No. 5,501,805.

The composition of fragrance materials may be in encapsulated form, for improved storage stability, e.g. at high temperatures, and to reduce odour impact prior to use. Preferred encapsulates are water-sensitive, being designed to release their contents on exposure to water. Suitable encapsulating material and techniques are well known to those skilled in the art, with suitable materials including starches and cyclodextrins: see e.g. U.S. Pat. No. 5,102,564, “Textile materials with fixed cyclodextrins as a fragrance depot”, Hans-Jurgen Buschmann et al, Perv. Flav., vol 27 May/June 2002, pages 36-38, and U.S. Pat. No. 5,425,887.

The article in accordance with the invention preferably comprises a liquid-absorbent pad for absorbing bodily fluids, such as urine etc. The article is intended for use external of the body, such as an incontinence pad, nappy or diaper etc. The invention especially concerns articles of this sort intended for use by female humans.

The composition of fragrance materials is conveniently absorbed in the liquid-absorbent pad of such an article.

The article may alternatively be in the form of a sheet of material impregnated with the composition of fragrance materials, e.g. an impregnated wipe or tissue, such as an impregnated baby wipe or tissue etc.

The article is generally a disposable article, intended for single use only.

The article may otherwise be of generally conventional construction and materials, e.g. as disclosed in WO 03/057111 and WO 02/098337.

Where the invention is embodied as an article such as an incontinence pad including a liquid-absorbent pad, the article typically comprises an absorbent core (constituting the liquid-absorbent pad) sandwiched between an upper layer of material, known as a top sheet, and a lower layer of material, known as a back sheet. The article may include one or more layers of liquid-impervious barrier material, in known manner.

The top sheet is of material that is permeable to fluids, to allow passage of urine etc towards the absorbent core, while keeping fluid away from the user's body. The top sheet may comprise one or more layers of material, and is typically made of woven or non-woven fabrics or films, e.g. a sheet of perforated plastics film etc.

The back sheet, or one or more layers of barrier material, functions to prevent fluids absorbed by the absorbent core from passing through the article and leaking onto adjacent garments of a user. The back sheet is thus usually impervious to fluids, and is commonly made of a thin, unperforated film of plastics materials e.g. polyethylene film. The back sheet and top sheet are typically of greater extent than the absorbent core, with peripheral portions of the two sheets secured together to retain the core therebetween. In incontinence pads, the back sheet at least may extend further laterally, to form side flaps or “wings”. Adhesive material may be applied to the outer face of the back sheet, to permit temporary attachment of the article to the clothing of a user.

The absorbent core functions to absorb and contain fluid and commonly comprises natural, modified or synthetic fibres, particularly modified or non-modified cellulose fibres in the form of fluff and/or tissues, or textile fibres such as rayon or polyester. The core may additionally include a superabsorbent material, usually a gelling material such as sodium polymethacrylate.

The composition of fragrance materials is conveniently absorbed into the absorbent core of such articles, e.g. by being applied to the core during manufacture of the article. The composition may additionally or alternatively be present in different parts of the article, e.g. being applied to one or both major faces of the core.

The composition of fragrance materials is used in an appropriate amount to obtain the desired effect in any given application. Suitable amounts can be readily determined by experiment. For example, for an article including an absorbent pad such as described above, e.g. an incontinence pad, a nappy or a diaper, the composition is typically present in an amount in the range 20 to 500 mg per article, preferably 50 to 300 mg per article, more preferably 100 to 200 mg per article.

The composition of fragrance materials is found to be particularly effective in overcoming or reducing malodours resulting from amine compounds, such as trimethylamine, known sometimes to be present in products of the genito-urinary tract.

The invention will be further described, by way of illustration, in the following Examples and with reference to the accompanying drawings, in which:

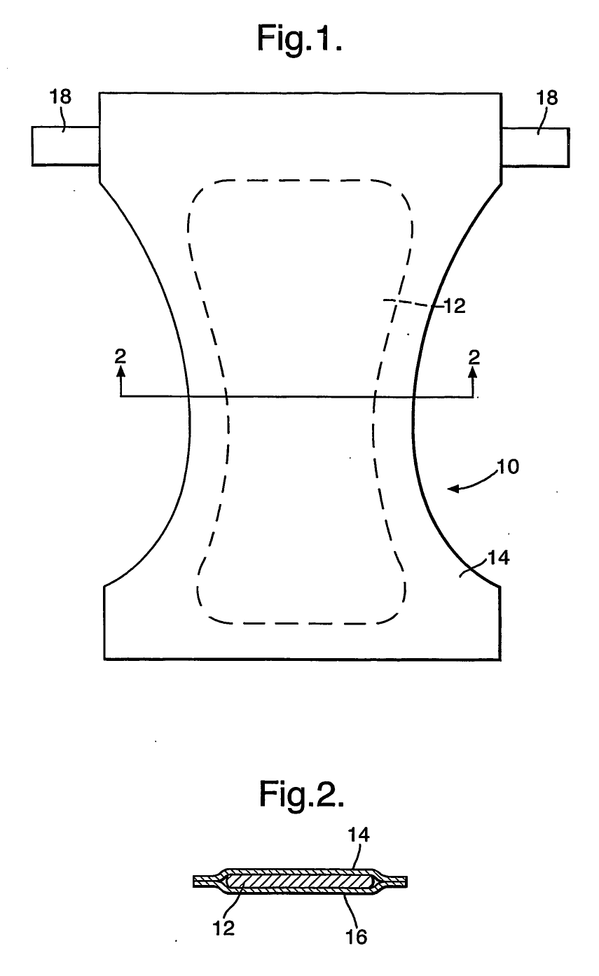

FIG. 1 is a schematic plan view of a diaper in accordance with the invention; and

FIG. 2 is a schematic sectional view (not to scale) of the diaper of FIG. 1 taken along line 2-2 of FIG. 1.

### DETAILED DESCRIPTION OF THE DRAWINGS

Referring to the drawings, there is illustrated a diaper 10 which comprises an absorbent core 12 sandwiched between a top sheet 14 and a back sheet 16. The core 12 comprises cellulosic fibres, and is generally rectangular in plan, with rounded corners. The top sheet 14 comprises a hydrophobic, liquid permeable apertured film. The back sheet 16 comprises a waterproof polyethylene film. Edge portions of the top sheet and bottom sheet extending beyond the core 12 are adhered together. Adhesive tabs 18 are provided to remit the diaper to be secured in position on a user.

In accordance with the invention, a composition of fragrance materials having an odour intensity index of less than about 110 is applied to the material of core 12 in an amount in the range 20 to 400 mg, to be absorbed by the core 12, prior to manufacture of the towel 10. The composition is conveniently as specified in one of the following Examples.

### EXAMPLE 1

Table 2 below gives the composition of 5 preferred compositions of fragrance materials for use in accordance with the present invention.

| | w/w % | | | | | |
|---|---|---|---|---|---|---|
| COMPONENT | | A | B | C | D | E |
| ACETYL CEDRENE | | 3.5 | | | 0.5 | |
| BENZYL CINNAMATE | | 0.5 | | | | |
| BENZYL SALICYLATE | Sa | 4 | | | | |
| CINNAMIC ALCOHOL | | 0.2 | | | | |
| CINNAMYL CINNAMATE | | | | 0.5 | | |
| cis-3-HEXENYL | Sa | | | 4.5 | 0.5 | |
| SALICYLATE | | | | | | |
| CYCLOHEXADECANOLIDE | M | 4.5 | | 5.5 | | |
| CYCLOHEXYL SALICYLATE | Sa | | | 1.5 | | |
| CYCLOPENTADECANONE | M | 4.5 | | 5.5 | | |
| DIPROPYLENE GLYCOL | S | | 4 | 0.6 | | 1.6 |
| DISPIRONE (TM) (Quest) | | | | 0.1 | | 0.2 |
| ETHYLENE BRASSYLATE | M | | 6.5 | | 15.7 | 5 |
| ETHYLENE | M | | | 12.3 | | |
| DODECANEDIOATE | | | | | | |
| FLOROSA (TM) (Quest) | | 5.5 | 0.1 | | 0.5 | 0.2 |
| GERANYL | | | 0.4 | | | |
| PHENYLACETATE | | | | | | |
| HABANOLIDE (TM) | M | | 2.5 | | | 3 |
| (Firmenich) | | | | | | |
| HEXYL SALICYLATE | Sa | 8 | 6 | 4 | 15 | 5 |
| ISOBORNYL | | 1.5 | | 0.7 | | 0.5 |
| CYCLOHEXANOL | | | | | | |
| ISOBUTYL BENZOATE | | 1.5 | | | | |
| ISOBUTYL CINNAMATE | | | | 0.1 | | |
| ISOPROPYL MYRISTATE | S | 52 | | 59 | 12.5 | |
| LINALYL BENZOATE | | | | 1.5 | | |
| LINALYL CINNAMATE | | | 0.5 | | | |
| MEFROSOL (TM) (Quest) | | 2.2 | | 0.5 | 1.3 | 1 |
| METHYL | | | 15 | 2.0 | 25 | 20 |
| DIHYDROJASMONATE | | | | | | |
| MUSK R1 (TM) (Quest) | M | 1.5 | | 1.2 | | |
| PHENOXYETHANOL | | 5.5 | 12 | | 14 | 15 |
| PHENYLETHYL | | 1.5 | | 0.5 | | |
| PHENYLACETATE | | | | | | |
| PHENYLETHYL | Sa | 3.6 | | | | |
| SALICYLATE | | | | | | |
| TETRAHYDROLINALOL | | | | | 2.5 | 0.5 |
| TRIACETIN | S | | | | 12.5 | |
| TRIETHYL CITRATE | S | | 53 | | | 48 |
| TOTAL | | 100 | 100 | 100 | 100 | 100 |
| % Musk | | 10.5 | 9 | 24.5 | 15.7 | 8 |
| % Salicylate | | 15.6 | 6 | 10 | 15.5 | 5 |
| % Other | | 21.9 | 28 | 5.9 | 43.8 | 37.4 |
| % Solvent | | 52 | 57 | 59.6 | 25 | 49.6 |

Note:
Sa = Salicylate
M = Musk and
S = Solvent

Perfume compositions A to E have an odour intensity index of less than 110.

### EXAMPLE 2

The perfumes of the invention may be assessed using standard malodour intensity assessment methods wherein malodour and counteractant may interact only in the gas phase or in the nose. Any reduction of malodour perception will occur primarily through sensory interactions (other mechanisms will of course be feasible in the case of intimate mixing of malodour and counteractant).

1 ml fragrance E in Example 1 was placed into a 15 ml jar and this was placed into a 500 ml jar alongside a similar jar containing 3 ml of a malodour model (0.1% w/w solution in diethyl phthalate of hexylamine).

The samples were assessed against a control containing malodour alone. The samples were randomised and coded and were olfactorilly assessed by trained sensory panellists employing magnitude estimation techniques. The results were analysed using Analysis of Variance and multiple comparison techniques.

Malodour intensity: Perfume E: LSMEAN SCORE=25
Control: LSMEAN SCORE=48

The malodour intensity was reduced by about 50%.

1. A method of counteracting or reducing odours associated with bodily fluids or solids, other than axillary malodour, comprising providing in the vicinity of the bodily fluid or solid or source thereof a composition of fragrance materials having an odour intensity index of less than about 110, excluding a method of counteracting or reducing odours associated in use with an article selected from sanitary towels or napkins and panty liners.

2. (canceled)

3. (canceled)

4. An article other than a sanitary towel or napkin or a panty liner for counteracting or reducing odours associated with bodily fluids or solids, other than axillary malodour, wherein the article includes a composition of fragrance materials having an odour intensity index of less than about 110.

5. An article according to claim 4, comprising a liquid-absorbent pad for absorbing bodily fluids.

6. An article according to claim 5, intended for use external of the body.

7. An article according to claim 6, comprising an incontinence pad, nappy or diaper.

8. An article according to claim 5, wherein the composition of fragrance materials is absorbed in the liquid-absorbent pad of the article.

9. An article according to claim 8, wherein the article is a disposable article, intended for single use only.

10. An article according to claim 9, wherein the composition of fragrance materials is present in an amount in the range 20 to 500 mg per article.

11. An article according to claim 4, in the form of a sheet of material impregnated with the composition of fragrance materials, for use as a disposable wipe.

12. An article according to claim 4, wherein the composition of fragrance materials has an odour intensity index of less than about 105.

13. An article according to claim 4, where the composition of fragrance materials comprises at least 5% w/w of at least one musk, based on the total weight of the composition.

14. An article according to claim 13, wherein the musk or musks are selected from the following: cyclohexadecen-7-olide, 4-acetyl-6-tert-butyl-1,1 -dimethylindane, cyclohexadecanolide, cyclo-1,13-ethylenedioxy-tridecan-1,13-dione, cyclopentadecanolide, cyclopentadecanone, 1-oxa-5(6)-cyclohexadecen-16-one, 1,3,4,6,7,8-hexahydro-4,6,6,7,8,8-hexamethylcyclopenta-2-benzopyran, 1,1,3,3,5 pentamethyl-4,6-dinitroindane, 2,4-dinitro-3-methyl-6-tert-butylanisole, 4-tert-butyl-3,5-dinitro-2,6-dimethylacetophenone, ethylene 1,12-dodecanedioate, 11-oxahexadecanolide, 2-tert-butyl-1,3-dinitrol-4,5,6-trinitrobenzene, 1-tert-butyl-3,5-dimethyl-2,4,6-trinitrobenzene, 5acetyl-1-1,1,2,3,3,6-hexamethylindane, 1,1,2,4,4,7-hexamethyl-6-acetyl-1,2,3,4-tetrahydronaphthalene.

15. An article according to claim 4, where the composition of fragrance materials comprises at least 5% w/w of at least one salicylate, based on the total weight of the composition.

16. An article according to claim 15, wherein the salicylate or salicylates are selected from the following: benzyl salicylate, cis-3-hexenyl salicylate, cyclohexyl salicylate, hexyl salicylate and phenylethyl salicylate.

17. An article according to claim 4, wherein the composition of fragrance materials contains at least 5% w/w of other perfume ingredients which are neither musk nor salicylate nor solvent that is odourless or substantially odourless, based on the total weight of the composition.

18. An article according to claim 10 wherein the composition of fragrance materials is present in an amount in the range of 50 to 300 mg per article.

19. An article according to claim 10 wherein the composition of fragrance materials is present in an amount in the range of 100 to 200 mg per article.

20. An article according to claim 12 wherein the composition of fragrance materials has an odor intensity index of less than about 100.

21. An article according to claim 13 wherein the composition of fragrance materials comprises at least 20% w/w of at least one musk based on the total weight of the composition.

22. An article according to claim 15 wherein the composition of fragrance materials comprises at least 10%, based on the total weight of the composition, of a salicylate of aliphatic or arylaliphatic alcohols containing at least three carbon atoms.

23. An article according to claim 15 wherein the composition of fragrance materials comprises at least 10%, based on the total weight of the composition, of a salicylate of aliphatic or arylaliphatic alcohols containing at least 3-10 carbon atoms.

24. An article according to claim 4, wherein the composition of fragrance materials contains at least 20% w/w of other perfume ingredients which are neither musk nor salicylate nor solvent that is odourless or substantially odourless, based on the total weight of the composition.

25. The method according to claim 1, wherein the composition of fragrance materials has an odour intensity index of less than about 105.

26. The method according to claim 1, where the composition of fragrance materials comprises at least 5% w/w of at least one musk, based on the total weight of the composition.

27. The method according to claim 26, wherein the musk or musks are selected from the following: cyclohexadecen-7-olide, 4-acetyl-6-tert-butyl-1,1-dimethylindane, cyclohexadecanolide, cyclo-1,13-ethylenedioxy-tridecan-1,13-dione, cyclopentadecanolide, cyclopentadecanone, 1-oxa-5(6)-cyclohexadecen-16-one, 1,3,4,6,7,8-hexahydro4,6,6,7,8,8-hexamethylcyclopenta-2-benzopyran, 1,1,3,3,5-pentamethyl-4,6-dinitroindane, 2,4-dinitro-3-methyl-6-tert-butylanisole, 4-tert-butyl-3,5-dinitro-2,6-dimethylacetophenone, ethylene 1,12-dodecanedioate, 11-oxahexadecanolide, 2-tert-butyl-1,3-dinitrol4,5,6-trinitrobenzene, 1-tert-butyl-3,5-dimethyl-2,4,6-trinitrobenzene, 5-acetyl-1,1,2,3,3,6-hexamethylindane, 1,1,2,4,4,7-hexamethyl-6-acetyl-1,2,3,4-tetrahydronaphthalene.

28. The method according to claim 1, where the composition of fragrance materials comprises at least 5% w/w of at least one salicylate, based on the total weight of the composition.

29. The method according to claim 28, wherein the salicylate or salicylates are selected from the following: benzyl salicylate, cis-3-hexenyl salicylate, cyclohexyl salicylate, hexyl salicylate and phenylethyl salicylate.

30. The method according to claim 4, wherein the composition of fragrance materials contains at least 5% w/w of other perfume ingredients which are neither musk nor salicylate nor solvent that is odourless or substantially odourless, based on the total weight of the composition.

31. The method of claim 25 wherein the composition of fragrance materials has an odour intensity index of less than about 100.

32. The method according to claim 26 wherein the composition of fragrance materials comprises at least 20% w/w of at least one musk, based on the total weight of the composition.

33. The method of claim 28 wherein the composition of fragrance materials comprises at least 10%, based on the total weight of the composition, of a salicylate of an aliphatic or arylaliphatic alcohol containing at least three carbon atoms.

34. The method of claim 33 wherein the alcohol contains from 3 to 10 carbon atoms.

35. The method of claim 30 wherein the composition contains at least 20% w/w of said other perfume ingredients based on the total weight of the composition.
